(19) United States
(12) Patent Application Publication
(10) Pub. No.: US 2025/0138994 A1
(43) Pub. Date: May 1, 2025

(54) MEMORY CONTROLLER, COMPUTATIONAL MEMORY APPARATUS, AND OPERATION METHOD FOR PROCESSING INPUT DATA, AND DATA PROCESSING SYSTEM INCLUDING THE SAME

(71) Applicant: SK hynix Inc., Gyeonggi-do (KR)

(72) Inventors: In Ho JUNG, Gyeonggi-do (KR); Min Hwan MOON, Gyeonggi-do (KR); Seong Bin CHOI, Gyeonggi-do (KR); Seung Gu JI, Gyeonggi-do (KR)

(21) Appl. No.: 18/607,561

(22) Filed: Mar. 18, 2024

(30) Foreign Application Priority Data
Oct. 27, 2023 (KR) 10-2023-0145600

(51) Int. Cl. G06F 12/02

(52) U.S. Cl. CPC G06F 12/0223

(57) ABSTRACT

A memory controller may include an external device interface configured to receive system configuration setting information from a first external device, a logical address feature map storage circuit configured to generate a logical address feature map by extracting, from the system configuration setting information, logical address feature data that defines a computational type for each logical address range specified by the first external device, a computational core configured to process write-requested data in a corresponding computational type, in response to a write request for a logical address included in the logical address feature map, and a memory interface configured to transmit the processed write data to a second external device.

### CROSS-REFERENCES TO RELATED APPLICATION

The present application claims priority under 35 U.S.C. § 119(a) to Korean application number 10-2023-0145600, filed on Oct. 27, 2023, which is incorporated herein by reference in its entirety.

### BACKGROUND

### 1. Technical Field

Various embodiments of the present disclosure generally relate to a computing device, and more particularly, to a memory controller, a computational memory apparatus, and an operation method for processing input data, and a data processing system including the same.

### 2. Related Art

As interest in and importance of artificial intelligence applications and big data analysis increases, demands for computing systems capable of efficiently processing large amounts of data are increasing.

As the capacity of a memory apparatus is increased and a computing speed is improved, research into an in-memory computing technology that performs not only data storage but also data computation within a memory or near the memory, and a memory near data processing (NDP) technology is being conducted.

The in-memory computing technology is attracting attention as a technology for processing artificial intelligence applications because the in-memory computing technology may reduce the amount of use of host (i.e., main system) resources and reduce the amount of data movement by performing computations inside a storage device and transmitting only result data to a host. Therefore, research into various methods for processing data more accurately and at higher speeds is being conducted.

### SUMMARY

A memory controller in accordance with an embodiment of the present disclosure may include: an external device interface configured to receive system configuration setting information from a first external device; a logical address feature map storage circuit configured to generate a logical address feature map by extracting, from the system configuration setting information, logical address feature data that defines a computational type for each logical address range specified by the first external device; a computational core configured to process write-requested data in a corresponding computational type, in response to a write request for a logical address included in the logical address feature map; and a memory interface configured to transmit the processed write-requested data to a second external device.

A memory controller in accordance with an embodiment of the present disclosure may be configured to receive a set features command that defines a computational type for each logical address range from an external device, to store the set features command, to process write data write-requested by the external device on the basis of a computational type corresponding to a logical address of the write data, and to store the processed write data in a nonvolatile memory apparatus.

A computational memory apparatus in accordance with an embodiment of the present disclosure may include: a memory controller configured to receive, from an external device, system configuration setting information that defines a computational type for each logical address range, extract logical address feature data that defines the computational type for each logical address range specified by the external device, and process write data write-requested by the external device based on a computational type corresponding to a logical address of the write data; and a nonvolatile memory apparatus configured to store the processed write data.

An operation method of a memory controller in accordance with an embodiment of the present disclosure is an operation method of the memory controller that communicates with an external device, and may include: receiving system configuration setting information from the first external device; generating a logical address feature map by extracting, from the system configuration setting information, logical address feature data that defines a computational type for each logical address range specified by the first external device; processing write-requested data in a corresponding computational type, in response to a write request for a logical address included in the logical address feature map; and transmitting the processed write-requested data to a second external device.

A data processing system in accordance with an embodiment of the present disclosure may include: in accordance with an embodiment of the present disclosure may include: an external device configured to transmit system configuration setting information including logical address feature data that defines a computational type for each logical address range; and a computational memory apparatus configured to extract the logical address feature data from the system configuration setting information to generate a logical address feature map, and to process and store write data write-requested by the external device on the basis of a computational type corresponding to a logical address of the write data.

A computational load of a main system can be reduced by preprocessing data to be processed within a memory apparatus.

### BRIEF DESCRIPTION OF THE DRAWINGS

FIG. 1 is a diagram illustrating a configuration of a data processing system in accordance with an embodiment of the present disclosure;

FIG. 2 is a diagram illustrating a detailed configuration of a memory controller in accordance with an embodiment of the present disclosure;

FIG. 3 is a diagram illustrating a detailed configuration of a preprocessing device in accordance with an embodiment of the present disclosure;

FIG. 4 is a diagram for describing a structure of logical address feature data in accordance with an embodiment of the present disclosure;

FIG. 5 is a diagram for describing a structure of a logical address feature map in accordance with an embodiment of the present disclosure;

FIG. 6 is a diagram for describing the type of preprocessing of input data in accordance with an embodiment of the present disclosure;

FIG. 7 is a sequence diagram for a method for setting and confirming a configuration of a computational memory apparatus in accordance with an embodiment of the present disclosure;

FIG. 8 is a sequence diagram for a data writing method in accordance with an embodiment of the present disclosure;

FIG. 9 is a sequence diagram for a data reading method in accordance with an embodiment of the present disclosure;

### DETAILED DESCRIPTION

Hereinafter, embodiments of the present disclosure are described in more detail with reference to the accompanying drawings.

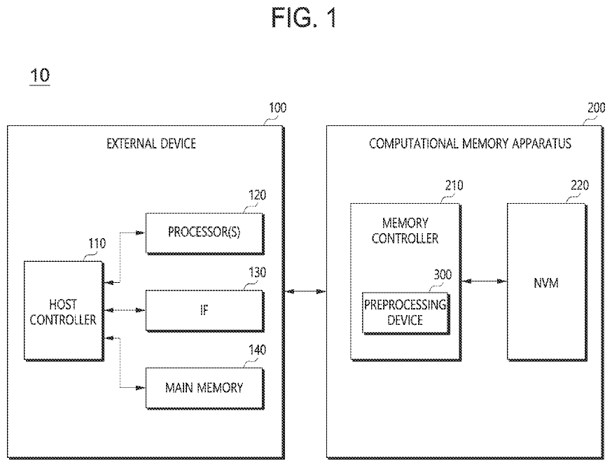

FIG. 1 is a diagram illustrating a configuration of a data processing system 10 in accordance with an embodiment of the present disclosure.

Referring to FIG. 1, the data processing system 10 may include an external device 100 and a computational memory apparatus 200.

The external device 100 may be, for example, a high performance computing (HPC) device capable of processing neural network or artificial intelligence tasks, but is not limited thereto.

The external device 100 may include a host controller 110, an arbitrary number of processor(s) 120, an interface (IF) 130, and a main memory 140.

The host controller 110 may control overall operations of the external device 100, and may be configured as a combination of software and hardware executing the software. In an embodiment, the host controller 110 may manage each hardware component and resources by running an operating system (OS) and to execute programs installed therein.

The processor(s) 120 may operate by executing, on hardware, firmware or software provided for various operations of the external device 100. In an embodiment, the processor(s) 120 may be hardware or a hardware accelerator capable of processing neural network operations.

The interface 130 may provide an environment in which the external device 100 may communicate with the computational memory apparatus 200.

The main memory 140 may store programs to be executed by the host controller 110 or the processor(s) 120, data, or results processed by the host controller 110 or the processor(s) 120.

The computational memory apparatus 200 may include a memory controller 210 and a nonvolatile memory apparatus (NVM) 220 that may be located outside the controller 210. In an embodiment, the external device 100 may be referred to as a first external device, and the NVM 220 may be referred to as a second external device.

The memory controller 210 may store data provided from the external device 100 in the NVM 220 in response to a write request from the external device 100, and provide data stored in the NVM 220 to the external device 100 in response to a read request from the external device 100.

The memory controller 210 may include a preprocessing device 300.

The preprocessing device 300 may extract logical address feature data (i.e., logical block address (LBA) range type data, also referred to as ‘LRT data’) from system configuration setting information provided by the external device 100, and generate a logical address feature map (i.e., LBA range type map, also referred to as ‘LRTM’).

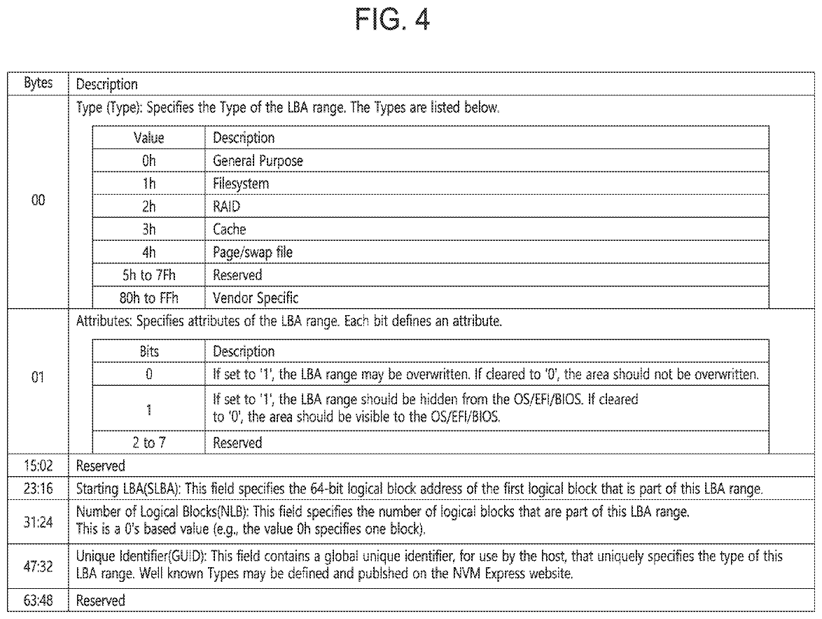

In an embodiment, the LRT data may be data that defines a preprocessing type for preprocessing data corresponding to a specific logical address in a format that can be processed by a neural network, which is described below with reference to FIGS. 4 to 6.

When the logical address of data write-requested by the external device 100 is included in the LRTM, the preprocessing device 300 may process the write data according to a preprocessing type set in the LRTM and store the processed data in the NVM 220.

The external device 100 may receive preprocessed data from the computational memory apparatus 200 and perform neural network operation, for example, learning.

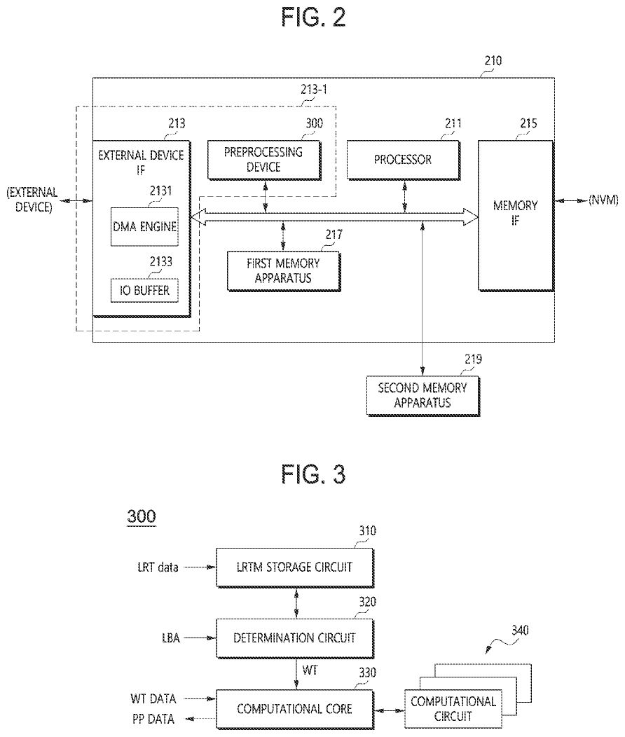

FIG. 2 is a diagram illustrating a detailed configuration of the memory controller 210 in accordance with an embodiment of the present disclosure.

Referring to FIG. 2, the memory controller 210 may include a processor 211, an external device interface (IF) 213, a memory interface (IF) 215, a first memory device 217, a second memory device 219, and a preprocessing device 300. Depending on the configuration, the preprocessing device 300 may be integrated with the external device IF 213 (see 213-1).

The processor 211 may be implemented as a combination of hardware and firmware/software operating on the hardware to operate by executing, on the hardware, firmware or software provided for various operations of the computational memory apparatus 200. In an embodiment, the processor 211 may perform a flash translation layer (FTL) function for managing the computational memory apparatus 200 such as address mapping, block management, garbage collection, and wear leveling.

The external device IF 213 may receive commands and clock signals from the external device 100 and provide a communication channel for controlling input and output of data under the control of the processor 211. The external device IF 213 may provide a physical connection between the external device 100 and the computational memory apparatus 200.

The external device IF 213 may include a direct memory access (DMA) engine 2131 and an input/output (IO) buffer 2133.

The IO buffer 2133 may store data transmitted and received between the external device 100 and the external device IF 213. In response to a system configuration setting request from the external device 100, the DMA engine 2131 may acquire system configuration setting information stored in the main memory 140 of the external device 100 and store, in the IO buffer 2133, the acquired system configuration setting information. In an embodiment, the system configuration setting information may include logical address feature data (i.e., LRT data). The LRT data may be data that defines a preprocessing type for logical addresses within a specific range.

In response to a write request from the external device 100, the DMA engine 2131 may acquire write data stored in the main memory 140 of the external device 100 and store the acquired write data in the IO buffer 2133. In response to a read request from the external device 100, the DMA engine 2131 may store, in the IO buffer 2133, read data to be provided to the external device 100.

In an embodiment, the external device IF 213 may communicate with an external device on the basis of an interface using at least one of various communication interfaces or standards such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA (SATA) protocol, a parallel-ATA (PATA) protocol, a small computer small interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, an improved inter-integrated circuit (I3C) protocol and the like.

The memory interface 215 may provide a communication channel for transmitting and receiving signals between the memory controller 210 and the NVM 220. The memory interface 215 may write data temporarily stored in a buffer memory (i.e., 217 or 219) to the NVM 220 under the control of the processor 211. Under the control of the processor 211, the memory interface 215 may transmit read data read from the NVM 220 to the buffer memory (217 or 219), and temporarily store the data.

The buffer memory may be implemented as at least one of the first memory device 217 and the second memory device 219. In an embodiment, the first memory device 217 may be provided inside the memory controller 210 and the second memory device 219 may be provided outside the memory controller 210.

The preprocessing device 300 may perform various types of preprocesses to convert data provided from the external device 100 into a format that can be processed by a neural network.

FIG. 3 is a diagram illustrating a detailed configuration of the preprocessing device 300 in accordance with an embodiment of the present disclosure.

Referring to FIG. 3, the preprocessing device 300 may include an LRTM storage circuit 310, a determination circuit 320, a computational core 330, and an arbitrary number of computational circuits 340.

The LRTM storage circuit 310 may generate the logical address feature map (LRTM) on the basis of the logical address feature data (LRT data) included in the system configuration setting information transmitted from the external device 100.

In an embodiment, the external device 100 may set the system configuration of the computational memory apparatus 200 by transmitting the set features command to the computational memory apparatus 200.

A feature identifier included in the set features command may include an entry that defines the logical address feature data (LRT data), and the preprocessing type for each logical address may be defined through the entry.

FIG. 4 is a diagram for describing a structure of the logical address feature data in accordance with an embodiment of the present disclosure.

Referring to FIG. 4, the LRT data includes a feature field (Type, 00), an attribute field (Attributes, 01), a first reserved field (Reserved, 15:02), a starting logical address field (Starting LBA (SLBA), 23:16), a logical address (LBA) number field (Number of Logical Blocks (NLB), 31:24), a logical area identifier field (Unique Identifier (GUID), 47:32), and a second reserved field (Reserved, 63:48).

Among data values that may be specified in the feature field (Type), a preprocessing type for a corresponding logical address may be defined using a vendor specific value (80h to FFh).

That is, a preprocessing type for data of the number of LBAs (Number of Logical Blocks (NLB), 31:24) specified from the starting logical address (Starting LBA (SLBA), 23:16) of a logical area indicated by the logical area identifier (Unique Identifier (GUID), 47:32) may be defined by the data value (80h to FFh) of the feature field (Type).

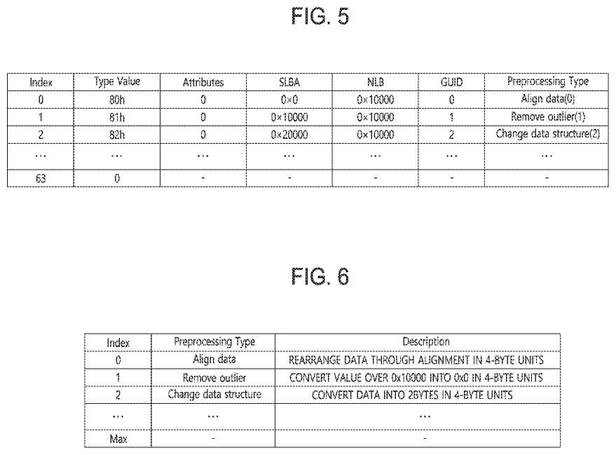

FIG. 5 is a diagram for describing a structure of the logical address feature map in accordance with an embodiment of the present disclosure.

The LRTM storage circuit 310 of the preprocessing device 300 may receive LRT data (for example, LRT data in the format illustrated in FIG. 4) included in the set features command, extract the value included in each field of the LRT data, and generate and store a logical address feature map (LRTM) illustrated in FIG. 5.

Referring to FIG. 5, index 0 of the LRTM defines that, in a logical area where the logical area identifier (GUID) is 0, data from the start logical address (SLBA) OXO to the number 0X10000 of LBAs (NLB) is preprocessed in an 80h type.

Index 1 defines that, in a logical area where the logical area identifier (GUID) is 1, data from the start logical address (SLBA) 0X10000 to the number 0X10000 of LBAs (NLB) is preprocessed in an 81h type.

Index 2 defines that, in a logical area where the logical area identifier (GUID) is 2, data from the start logical address (SLBA) 0X20000 to the number 0X10000 of LBAs (NLB) is preprocessed in an 82h type.

The preprocessing types 80h to 82h may be data alignment Align data, outlier (noise) removal Remove Outlier, structure (dimension) conversion Change data structure, and the like, but are not limited thereto. The preprocessing types may include, for example, duplicate value removal, missing value correction, data linkage/integration, data vectorization, outlier detection, feature Engineering, and the like.

The computational core 330 may be implemented as a combination of hardware and software operating on the hardware to support various preprocessing types by using the computing circuit 340.

FIG. 6 is a diagram for describing the preprocessing type of input data in accordance with an embodiment of the present disclosure.

A write request may be received from the external device 100 after LRTM is generated and stored.

The determination circuit 320 of the preprocessing device 300 may determine whether a logical address (LBA) included in the write request is included in the LRTM.

When the logical address (LBA) of data requested to be written is included in the LRTM, the computational core 330 may process write data WT DATA according to a preprocessing type set in the LRTM by using the computational circuits 340. The computational core 330 may store preprocessed data PP DATA in the NVM 220.

When a neural network operation is required, the external device 100 may receive the preprocessed data PP DATA from the computational memory apparatus 200 and process the preprocessed data PP DATA without a preprocessing process.

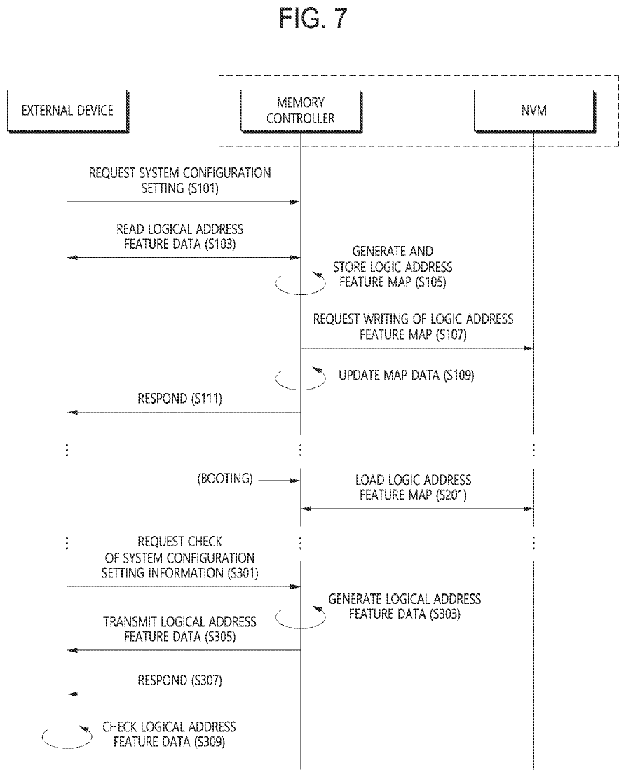

FIG. 7 is a sequence diagram for describing a method for setting and confirming the configuration of the computational memory apparatus 200 in accordance with an embodiment of the present disclosure.

Referring to FIG. 7, the external device 100 may, for example, transmit a set features command to the computational memory apparatus 200 and request to set the system configuration of the computational memory apparatus 200 (S101).

The external device IF 213 of the memory controller 210 included in the computational memory apparatus 200 may acquire logical address feature data (LRT data) stored in the external device 100 in response to the system configuration setting request (S103).

The preprocessing device 300 of the memory controller 210 may receive the logical address feature data (LRT data), extract a value included in each field of the logical address feature data (LRT data), and generate and store the logic address feature map (LRTM) illustrated in FIG. 5, for example (S105).

The preprocessing device 300 may request the NVM 220 to program a logical address feature map (LRTM) (S107), thereby causing a logical address feature map (LRTM) to be programmed into the NVM 220.

The memory controller 210 may update map data associated with the logical address feature map (LRTM) programmed into the NVM 220 (S109), and respond to the external device 100 that the storage of the system configuration setting information has been completed (S111).

Through such a procedure, the logical address feature map (LRTM) stored in the NVM 220 may be loaded to the memory controller 210 during a booting process of the computational memory apparatus 200 (S201).

When the external device 100 intends to check previously set system configuration setting information, the external device 100 may transmit, for example, a Get Features command to the computational memory apparatus 200 (S301).

The preprocessing device 300 of the memory controller 210 included in the computational memory apparatus 200 may generate logical address feature data (LRT data) on the basis of the logical address feature map (LRTM) (S303).

The memory controller 210 may transmit the logical address feature data (LRT data) generated by the preprocessor 300 to the external device 100 (S305), and respond to the external device 100 that the output of the system configuration setting information has been completed (S307).

The external device 100 may check the preprocessing type set for each logical address range by checking the logical address feature data (LRT data) (S309).

By setting the data preprocessing type, for example, with the set features command, the preprocessing type may be specified for each logical address range. Moreover, the preprocessing type for each logical address may be easily managed depending on the type and purpose of the neural network operation.

When no data preprocessing is necessary, since the logical address feature data may be initialized, the data processing system may be applied to various purposes and environments.

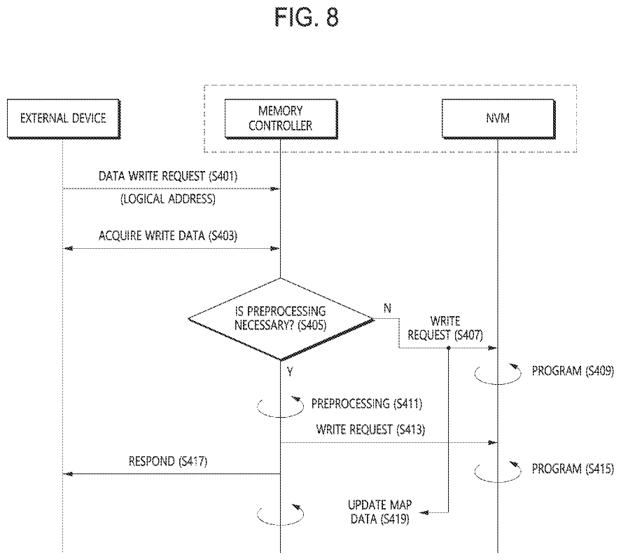

FIG. 8 is a sequence diagram for describing a data writing method in accordance with an embodiment of the present disclosure.

The external device 100 may transmit a data write request including a logical address (LBA) to the computational memory apparatus 200 (S401).

Write data write-requested by the external device 100 may be transmitted from the external device 100 to the memory controller 210 and buffered, for example, in the IO buffer 2133 within the external device IF 213 (S403).

The preprocessing device 300 of the memory controller 210 included in the operational memory apparatus 200 may check whether the logical address (LBA) included in the write request is included in the logical address feature map (LRTM), and determine whether preprocessing on the write-requested data is needed (S405).

When no preprocessing on the write-requested data is necessary (‘N’ in S405), the memory controller 210 may request programming of the write data into the NVM 220 (S407). In such a case, it is obvious that a process of converting the write-requested logical address (LBA) into a physical address precedes. The NVM 220 may program write data into a corresponding physical address area (S409) and update map data associated with the write data (S419).

When preprocessing on the write-requested data is necessary (‘Y’ in S405), the preprocessing device 300 of the memory controller 210 may preprocess the write data according to the preprocessing type included in the logical address feature map (LRTM) (S411).

After the preprocessing is completed, the memory controller 210 may convert the write-requested logical address (LBA) into a physical address and request the write data to be written to the NVM 220 (S413). The NVM 220 may program the preprocessed write data into the corresponding physical address area (S415).

The memory controller 210 may transmit a response signal indicating the success or failure of the processing of the write request to the external device 100 (S417), and update map data associated with the write data (S419).

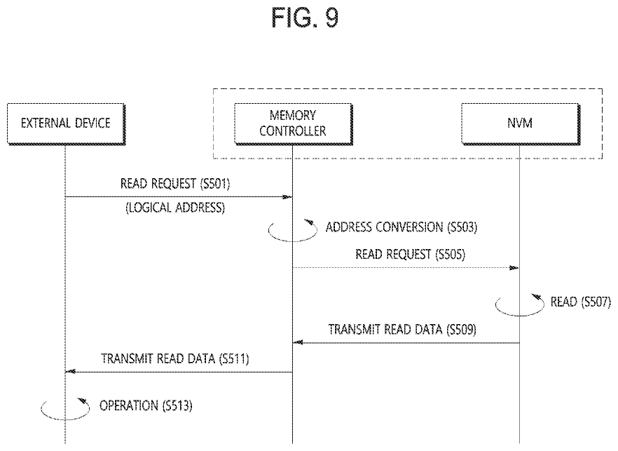

FIG. 9 is a sequence diagram for describing a data reading method in accordance with an embodiment of the present disclosure.

The external device 100 may transmit a data read request including a logical address (LBA) to the computational memory apparatus 200 (S501).

The memory controller 210 of the computational memory apparatus 200 may convert the read-requested logical address into a physical address (S503), and send a read request to the NVM 220 (S505).

The NVM 220 may read data from an area corresponding to the physical address (S507), and transmit the read data to the memory controller 210 (S509). The memory controller 210 may provide the read data to the external device 100 (S511).

The data read-requested by the external device 100 may be data preprocessed for neural network operation, and the external device 100 may process the neural network operation by using the read data provided from the computational memory apparatus 200 (S513).

As the data required for the neural network operation of the external device 100 is preprocessed in the computational memory apparatus 200, a computational load and an amount of power consumption of the external device 100 can be reduced.

A person skilled in the art to which the present disclosure pertains can understand that the present disclosure may be carried out in other specific forms without changing its technical spirit or essential features. Therefore, it should be understood that the embodiments described above are illustrative in all aspects, not limitative. The scope of the present disclosure is defined by the claims to be described below rather than the detailed description, and it should be construed that all changes or modified forms derived from the meaning and scope of the claims and the equivalent concept thereof are included in the scope of the present disclosure. Furthermore, the embodiments may be combined to form additional embodiments.

What is claimed is:

1. A memory controller comprising:
an external device interface configured to receive system configuration setting information from a first external device;
a logical address feature map storage circuit configured to generate a logical address feature map by extracting, from the system configuration setting information, logical address feature data that defines a computational type for each logical address range specified by the first external device;
a computational core configured to process write-requested data in a corresponding computational type, in response to a write request for a logical address included in the logical address feature map; and
a memory interface configured to transmit the processed write-requested data to a second external device.

2. The memory controller according to claim 1, wherein the computational core is configured to preprocess the write-requested data provided by the first external device into a format that is processed by a neural network.

3. The memory controller according to claim 1, wherein the system configuration setting information is included in a set features command.

4. The memory controller according to claim 3, wherein the logical address feature map storage circuit is configured to generate the logical address feature map by extracting, from the logical address feature data of the set features command, at least a feature field, an attribute field, a starting logical address field, a logical address number field, and a logical area identifier field.

5. The memory controller according to claim 4, wherein the logical address feature map storage circuit is configured to extract the computational type from a vendor specific value of the feature field.

6. The memory controller according to claim 1, wherein the first external device includes a host and the second external device includes a nonvolatile memory apparatus.

7. A computational memory apparatus comprising:
a memory controller configured to
receive, from an external device, system configuration setting information that defines a computational type for each logical address range,
extract logical address feature data that defines the computational type for each logical address range specified by the external device, and
process write data write-requested by the external device based on a computational type corresponding to a logical address of the write data; and
a nonvolatile memory apparatus configured to store the processed write data.

8. The computational memory apparatus according to claim 7, wherein the memory controller is configured to preprocess the write data provided by the external device in a format that is processed by a neural network.

9. The computational memory apparatus according to claim 7, wherein the system configuration setting information is included in a set features command.

10. The computational memory apparatus according to claim 9, wherein the memory controller is configured to generate a logical address feature map by extracting, from the logical address feature data of the set features command, at least a feature field, an attribute field, a starting logical address field, a logical address number field, and a logical area identifier field.

11. The computational memory apparatus according to claim 10, wherein the memory controller is configured to extract the computational type from a vendor specific value of the feature field.

12. An operation method of a memory controller that communicates with a first external device, the operation method comprising:
receiving system configuration setting information from the first external device;
generating a logical address feature map by extracting, from the system configuration setting information, logical address feature data that defines a computational type for each logical address range specified by the first external device;
processing write-requested data in a corresponding computational type, in response to a write request for a logical address included in the logical address feature map; and
transmitting the processed write-requested data to a second external device.

13. The operation method according to claim 12, wherein the processing the write-requested data comprises:
preprocessing the write-requested data provided by the first external device in a format that is processed by a neural network.

14. The operation method according to claim 12, wherein the receiving the system configuration setting information comprises receiving a set features command.

15. The operation method according to claim 14,
wherein the generating the logical address feature map comprises generating the logical address feature map by extracting, from the logical address feature data of the set features command, at least a feature field, an attribute field, a starting logical address field, a logical address number field, and a logical area identifier field.

16. The operation method according to claim 15, wherein the generating the logical address feature map further comprises extracting the computational type from a vendor specific value of the feature field.

17. The operation method according to claim 12, wherein the first external device includes a host and the second external device includes a nonvolatile memory apparatus.
